(19) United States
(12) Patent Application Publication
(10) Pub. No.: US 2018/0134089 A1
(43) Pub. Date: May 17, 2018

(54) Tire Including A Block Having A Plurality Of Cutouts

(71) Applicant: COMPAGNIE GENERALE DES ETABLISSEMENTS MICHELIN, Clermont-Ferrand (FR)

(72) Inventors: Benoit DURAND-GASSELIN, Clermont-Ferrand Cedex 9 (FR); Kenji FUKUDA, Clermont-Ferrand Cedex 9 (FR); Kazunori INABA, Clermont-Ferrand Cedex 9 (FR)

(73) Assignee: Compagnie Generale Des Etablissements Michelin, Clermont-Ferrand (FR)

(21) Appl. No.: 15/571,920

(22) PCT Filed: May 4, 2016
(86) PCT No.: PCT/FR2016/051059

§ 371 Date: Nov. 6, 2017

(30) Foreign Application Priority Data
May 7, 2015 (FR) 15/54096

(51) Int. Cl. B60C 11/03; B60C 11/12

(52) U.S. Cl. CPC B60C 11/0306; B60C 11/1236; B60C 2011/1209; B60C 2011/0388; B60C 2011/039; B60C 2011/0341

(57) ABSTRACT

A tire made of rubbery material comprising a tread (1), said tread having a width C measured between two edges (3) of the tread, the tread comprising a tread surface (5) intended to come into contact with the ground. The tread surface (5) comprises two shoulder regions (7a, 7b) surrounding a central region (9), at least one of the two shoulder regions (7a, 7b) comprising a plurality of successive cutouts (11a, 11b) in a circumferential direction (X). All or some of the cutouts (11a, 11b) of the plurality of cutouts extend obliquely, each cutout having two ends (13a, 13b), and when a cutout (11a) reaches one of its ends (13b), another cutout (11b) starts out at the same circumferential level (N) in the shoulder region (7a).

### FIELD OF THE INVENTION

The present invention relates to a tread for a motor vehicle tire provided with means for substantially reducing running noise.

### PRIOR ART

Usually, passenger vehicle tires are provided with a carcass reinforcement which nowadays is radial in the great majority of cases; in this configuration, the reinforcers of the carcass reinforcement are disposed so as to make an angle greater than or equal to 80 degrees and less than 100 degrees with a circumferential direction.

Moreover, tires are provided with a crown reinforcement comprising a plurality of reinforcers embedded in an elastomer-based material. This crown reinforcement is covered radially on the outside by a tread made of rubbery material, this tread having a surface, referred to as the tread surface, intended to be in contact with the road during running

In order to ensure a level of safety that is essential when driving in the wet, notably, it is a known procedure to provide the tread with a plurality of longitudinal grooves of circumferential overall orientation.

One drawback with the presence of longitudinal grooves is the generation of vibrations in the air flowing through these grooves, notably in the region of contact with the road. These vibrations are the source of resonances that generate running noise.

The document EP0324605 discloses a tread comprising a plurality of blocks aligned in a circumferential direction. In that document, the blocks are inclined at a particular angle on the tread surface in order to reduce the generation of running noise.

A tread comprising a tread surface, the tread surface having two shoulder regions surrounding a central region, is known. The shoulder regions comprise a plurality of transverse sipes that following one another in a circumferential direction. These transverse sipes notably have the purpose of improving grip on wet ground. However, the inventors have found that these transverse sipes generate noise of non-negligible intensity when they pass into the region of contact with the ground during running.

There is a need to limit the generation of noise by a tread, notably the noise generated in the shoulder regions of this tread.

Definitions

A “tire” means all types of resilient tread, whether or not it is subjected to an internal pressure.

The “tread” of a tire means a quantity of rubbery material delimited by lateral surfaces and by two main surfaces, one of which is intended to come into contact with a road surface when the tire is being driven on.

The “tread surface” means the set of points of the tread that are in contact with the road surface when the tire, inflated to its reference pressure, is running on this road surface. The reference inflation pressure is defined under the use conditions of the tire as defined notably by the E.T.R.T.O. (“European Tire and Rim Technical Organisation”) standard.

A “block” on a tread means a raised element delimited by grooves and comprising lateral walls and a contact face, the latter being intended to come into contact with the ground during running

An “elongate block” means a block having a width and a length around the circumference of the tire, this length being much greater than the width.

A “rib” means an elongate block which extends around the entire circumference of the tire.

A “groove” means a cutout in the tread delimiting walls of material, the width of this cutout being such that the walls associated with this cutout cannot come into contact with one another under normal running conditions. The width of a groove is greater than 2 millimetres.

A “sipe” means a cutout in the tread delimiting walls of material, the width of this cutout being suitable for allowing the walls of the sipe to come at least partially into contact as they pass through the contact patch in which the tire is in contact with the ground. The width of a sipe is less than or equal to 2 millimetres.

A “transverse direction” or “axial direction” means a direction parallel to the axis of rotation of the tire.

A “circumferential direction” means a direction tangential to any circle centred on the axis of rotation. This direction is perpendicular to the axial direction.

An “oblique direction” means a direction that has an axial component and a circumferential component, neither of which is zero.

A “circumferential level” means a set of points that form a straight line, this straight line being perpendicular to the circumferential direction.

A “circumferential level” means a set of points that form a straight line, this straight line being perpendicular to the circumferential direction.

A “median plane” means a plane perpendicular to the axis of rotation of the tire and passing through the middle of the tread.

### SUMMARY OF THE INVENTION

The invention relates to a tire made of rubbery material, comprising a tread. The tread has a width W measured between two edges of the tread, the tread comprising a tread surface intended to come into contact with the ground, the tread surface comprising two shoulder regions surrounding a central region. At least one of the two shoulder regions comprises a plurality of cutouts that follow one another in a circumferential direction. All or some of the cutouts of the plurality of cutouts extend obliquely, each cutout having two ends, and in that when a cutout reaches one of its ends, another cutout starts out at the same circumferential level in the shoulder region.

The invention therefore proposes ensuring continuity in the organization of the cutouts in the shoulder region. Specifically, when a cutout reaches one of its ends, another cutout starts out at the same circumferential level. This limits the variation in the void ratio in the shoulder region in the circumferential direction and the acoustic performance of the tire is improved as a result.

In one variant embodiment, the oblique cutouts make an angle α with a transverse direction. The angle α is between 5 degrees and 60 degrees. Preferably, the angle is between 15 degrees and 45 degrees.

The grip performance of the tire on wet ground, notably when cornering, is improved when the shoulder regions of the tread are most heavily loaded.

In another variant embodiment, the oblique cutouts are continued by generally transverse cutout extensions. These cutout extensions extend from the oblique cutouts as far as an edge of the tread, and in that the length of the cutout extensions is less than 10% of the width W of the tread.

The transverse cutout extensions make it possible to limit the noise generated during cornering, that is to say when there is a transfer of load from the centre of the tread to one of the shoulder regions.

In another variant embodiment, the oblique cutouts open into a circumferential groove belonging to the central region of the tread.

This facilitates the flattening of the tread on the ground and generally improves the grip of the tire on wet ground.

In another variant embodiment, each shoulder region comprises a set of oblique cutouts, and in that the cutouts of the two shoulder regions are symmetrical with respect to a median plane.

The cutouts are then particularly suitable for use in directional tread patterns.

In another variant embodiment, each shoulder region comprises a set of oblique cutouts, and in that the cutouts of the two shoulder regions are not symmetrical with respect to a median plane.

The cutouts are then particularly suitable for use in non-directional tread patterns.

In another variant embodiment, the two sets of oblique cutouts are offset with respect to one another in the circumferential direction.

This avoids coupling of the noise between the two sets of cutouts. A situation in which the cutouts of the two sets of cutouts come into simultaneous contact with the ground is thus avoided and the acoustic performance of the tire is thus generally improved.

In one variant embodiment, the cutouts are sipes.

This improves the grip of the tread on wet ground while retaining a degree of overall stiffness of the shoulder regions.

In one variant embodiment, the cutouts are grooves.

This improves the flow of water out of the tread when the tire is running on wet ground.

In one variant embodiment, the central region of the tread comprises at least one elongate block extending in the circumferential direction. The elongate block comprises a contact surface intended to come into contact with the ground and a first lateral wall and a second lateral wall delimiting this contact surface. The elongate block comprises a plurality of cutouts that open onto the contact surface of the block. Each cutout extends in an oblique direction opening onto the first lateral wall and onto the second lateral wall. The cutouts in the block are oriented in the same direction and the cutouts are distributed over the contact surface of the elongate block in such a way that when one cutout reaches the second lateral wall another cutout starts out from the first lateral wall, at the same circumferential level on the elongate block.

This ensures continuity in the organization of the cutouts in the elongate block and the noise generated by this elongate block is limited.

In another variant embodiment, the central region comprises at least one elongate block extending in the circumferential direction (X) of width W and length L, where L>>W, the elongate block comprising a contact surface intended to come into contact with the ground and a first lateral wall and a second lateral wall delimiting this contact surface. The elongate block comprises a plurality of oblique cutouts that open either onto the first lateral wall or onto the second lateral wall and extend as far as cutout ends which do not open out onto said lateral walls. The cutouts of the plurality of cutouts are distributed over the contact surface of the block in such a way that when one cutout reaches its cutout end another cutout starts out from a lateral wall, at the same circumferential level on the elongate block.

In another variant embodiment, the central region comprises at least one elongate block extending in the circumferential direction of width W and length L, where L>>W, the elongate block comprising a contact surface intended to come into contact with the ground and a first lateral wall and a second lateral wall delimiting this contact surface. The elongate block comprises a plurality of cutouts that open onto the contact surface of the elongate block. The cutouts extend in an oblique direction from the first lateral wall in the direction of the second lateral wall as far as cutout ends. For at least one cutout, its end does not open onto the second lateral wall, and when this cutout reaches its cutout end, another cutout starts out from the first lateral wall, at the same circumferential level on the elongate block.

### BRIEF DESCRIPTION OF THE DRAWINGS

Other features and advantages of the invention will become apparent from the following description, given by way of non-limiting example, with reference to the attached drawings in which:

FIG. 1 schematically shows a partial view of a tread having sipes, according to a first embodiment of the invention;

FIG. 2 schematically shows a second variant embodiment of the invention having sipes;

FIG. 3 schematically shows a third variant embodiment of the invention having sipes;

FIG. 4 schematically shows a fourth variant embodiment of the invention having sipes;

FIG. 5 schematically shows a fifth variant embodiment of the invention having sipes;

FIG. 6 schematically shows a sixth variant embodiment of the invention having sipes;

FIG. 7 schematically shows a seventh variant embodiment of the invention having sipes;

FIG. 8 schematically shows an eighth variant embodiment of the invention having sipes;

FIG. 9 schematically shows a ninth variant embodiment of the invention having sipes;

FIG. 10 schematically shows a partial view of a tread having grooves, according to a tenth variant embodiment of the invention;

FIG. 11 schematically shows an eleventh variant embodiment of the invention having grooves;

FIG. 12 schematically shows a twelfth variant embodiment of the invention having grooves;

FIG. 13 schematically shows a thirteenth variant embodiment of the invention having grooves;

FIG. 14 schematically shows a fourteenth variant embodiment of the invention having grooves;

FIG. 15 schematically shows a fifteenth variant embodiment of the invention having grooves;

FIG. 16 schematically shows a sixteenth variant embodiment of the invention having grooves;

FIG. 17 schematically shows a seventeenth variant embodiment of the invention having grooves;

FIG. 18 schematically shows an eighteenth variant embodiment of the invention having grooves.

In the following description, elements which are substantially identical or similar will be denoted by identical references.

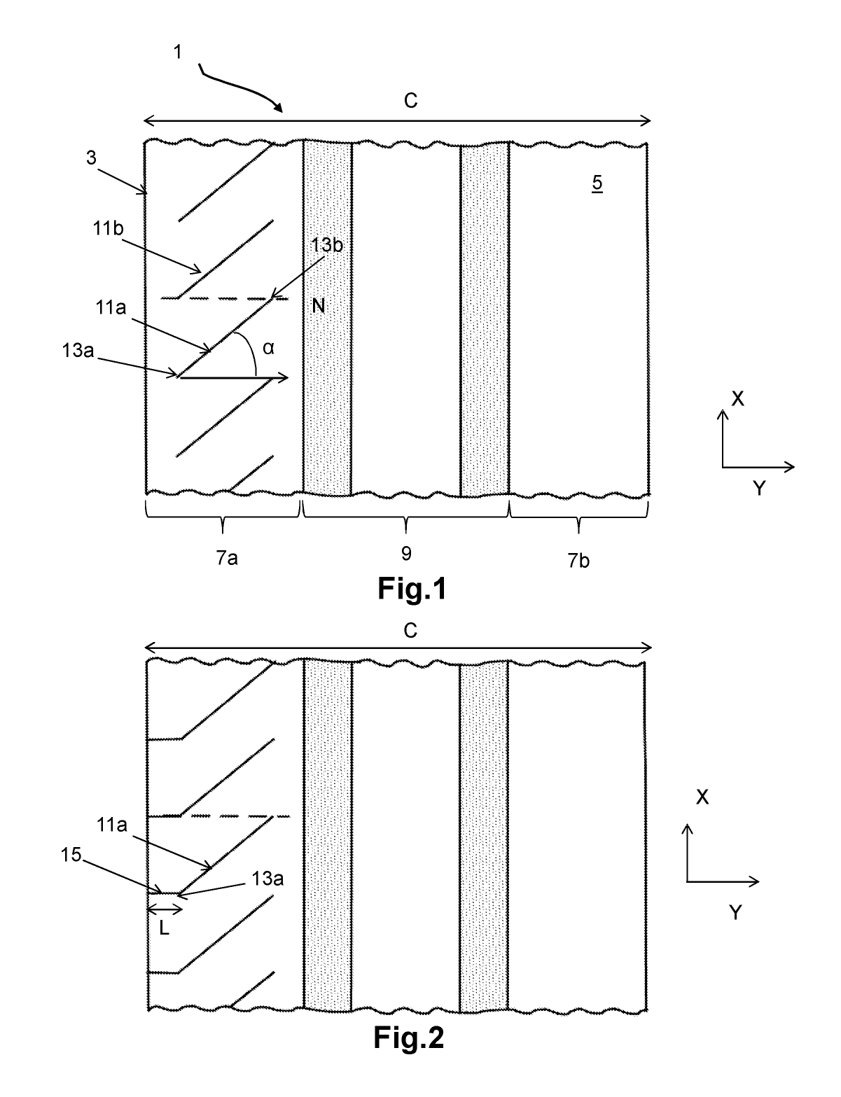

FIG. 1 and FIG. 10 each show a partial view of a tread 1 of a tire according to a first embodiment of the invention.

The tread 1 comprises a tread surface 5 intended to come into contact with the ground. This tread surface has a width C, which is measured between two edges 3 of the tread. This width C of the tread surface is notably defined by the ETRTO standard such that C=(1.075−0.005ar)*S^{1.001}, where ar is the nominal aspect ratio and s is the theoretical section width on a measuring rim.

More particularly, the tread surface comprises two shoulder regions 7a, 7b surrounding a central region 9. The shoulder regions mean the regions of the tread surface which are situated close to the edges 3 of this tread. The shoulder regions 7a, 7b are in this case made up of two elongate blocks extending in a circumferential direction X. At least one of the shoulder regions comprises a plurality of cutouts 11a, 11b. In the case of FIG. 1 and of FIG. 10, the cutouts 11a, 11b are sipes. In the case of FIG. 10, the cutouts 11a, 11b are grooves. These cutouts follow one another in the circumferential direction X. Each cutout extends between two ends 13a, 13a, making a non-zero angle α with a transverse direction Y. The angle α is, in this case, between 5 degrees and 60 degrees and preferably between 15 degrees and 45 degrees. The cutouts 11a, 11b are noteworthy in that, when the cutout 11a reaches one of its ends 13b, another cutout 11b starts out at the same circumferential level N in the shoulder region 7a. In the case in which the cutouts are grooves, the neutral axis concept is used to determine the same circumferential level between two adjacent grooves. The neutral axis of a groove divides this groove into two ½ grooves having substantially the same volume.

The cutouts 11a, 11b in this case have a simple rectilinear shape. Alternatively, these cutouts 11a, 11b can form curved lines on the surface of the tread, or more complex lines that can comprise different segments having different inclinations or can comprise different curves having different curvatures. In these particular cases, the angle α is determined between the straight line passing through the two ends 13a, 13b and corresponding to a mean line of the cutout, and the transverse direction Y.

It will also be noted that the end 13a of the cutout 11a does not in this case open onto the edge 3 of the tread. More particularly, the distance between this end 13a and this edge is greater than 0 and less than 10% of the width C of the tread. In this way, even if the use conditions of the tire vary (load, inflation pressure), coincidence of the cutouts at the same circumferential level N in the tread is preserved.

In the example in FIG. 2 and FIG. 11, the oblique cutout 11a is continued at its end 13a by a generally transverse cutout extension 15 extending as far as the edge 3 of the tread. The expression “generally transverse” means that the cutout extension makes an angle of less than 5 degrees with the transverse direction Y. The length L of the cutout extension is greater than 0 and less than 10% of the width C of the tread. In a preferred embodiment, the cutout extensions continue beyond the edge 3 of the tread.

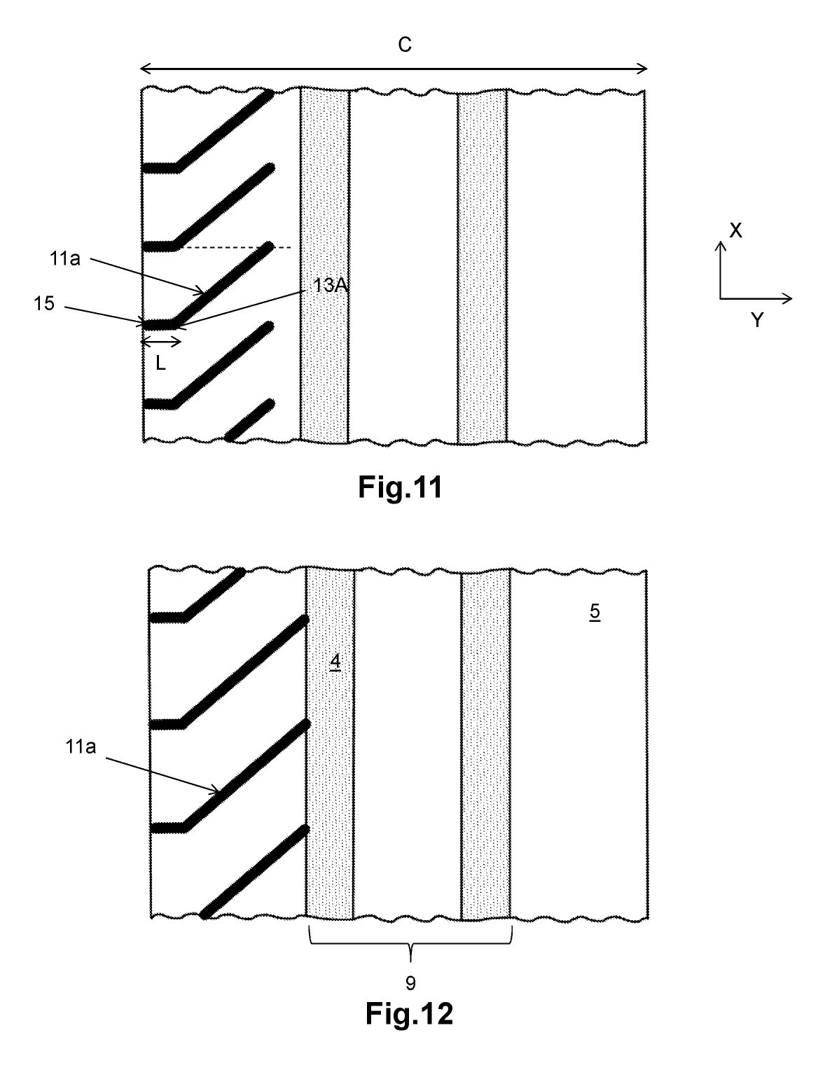

FIG. 3 and FIG. 12 describe a particular embodiment in which the cutouts 11a, 11b open into a circumferential groove 4 belonging to the central region 9 of the tread surface 5.

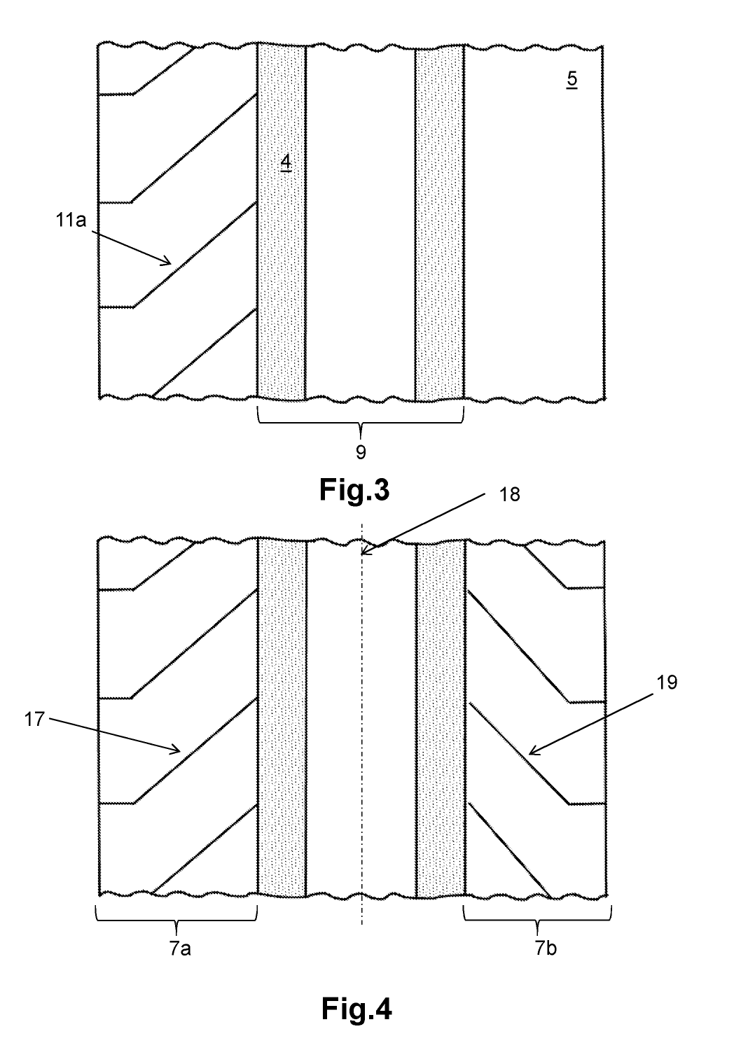

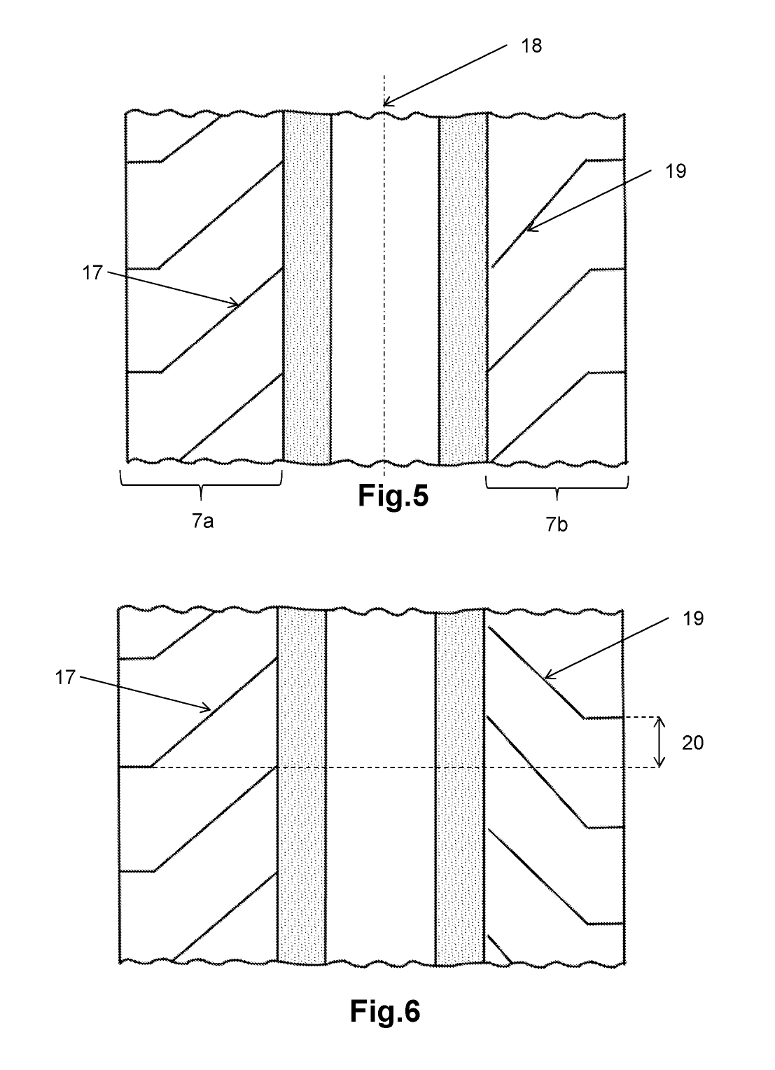

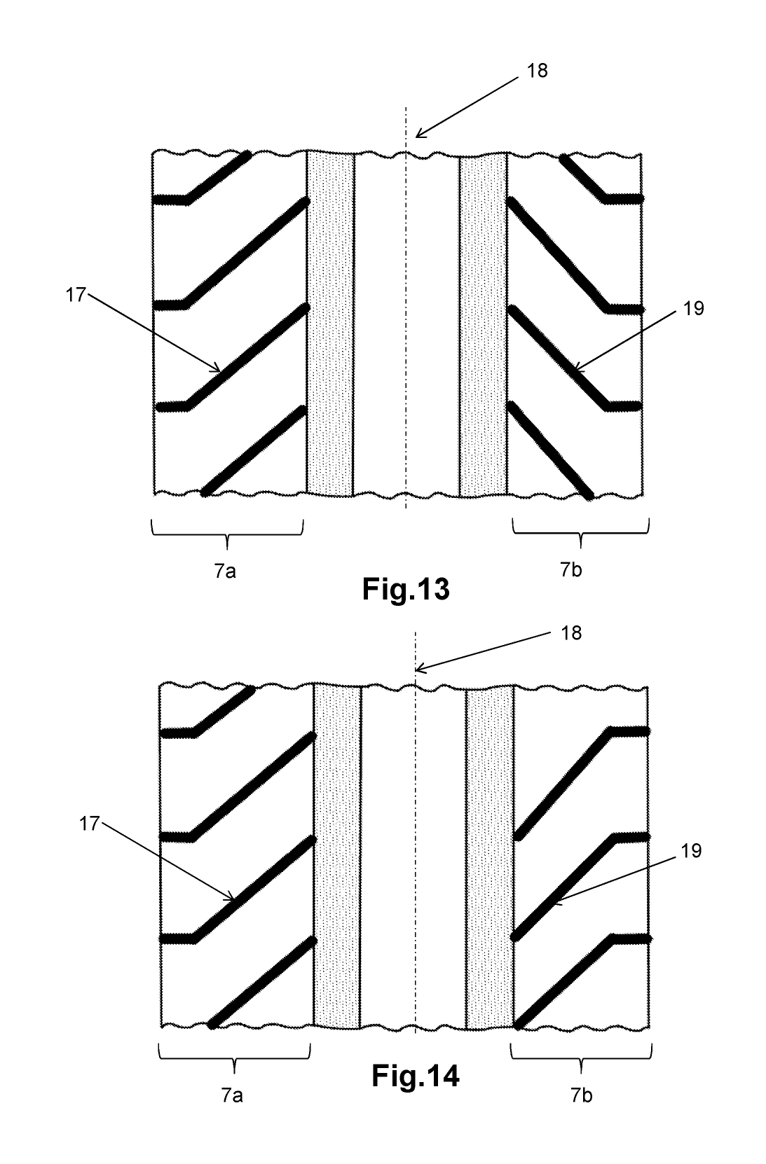

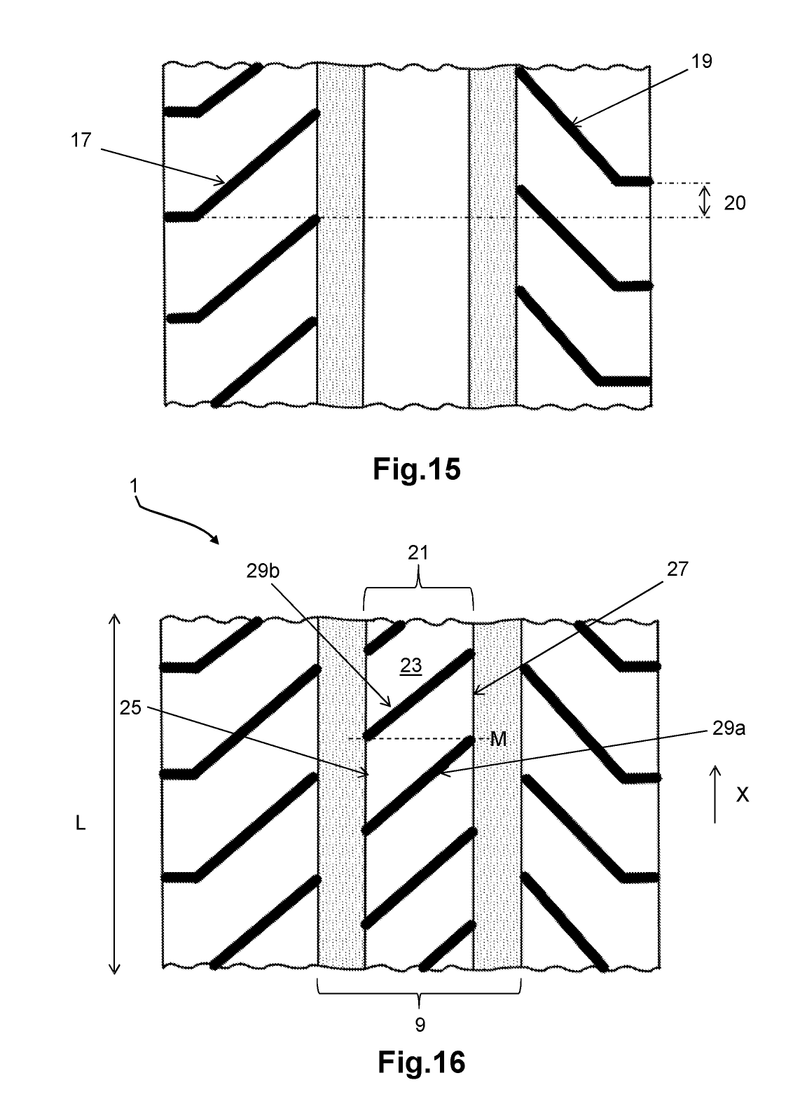

FIGS. 4 to 6 and FIGS. 13 to 15 describe embodiments in which each shoulder region 7a, 7b comprises a set of cutouts 17, 19. In the embodiment in FIG. 4 and in FIG. 13, the sets of cutouts 17, 19 are symmetrical with respect to a median plane 18. By contrast, in the embodiment in FIG. 5 and in FIG. 14, the sets of cutouts 17, 19 in the two shoulder regions are not symmetrical with respect to this median plane 18. In FIG. 6 and in FIG. 15, the sets of cutouts 17, 19 are offset with respect to one another in the circumferential direction. This offset 20 is, for example, between 5 and 10 mm. Such an offset can occur when the sets of cutouts 17, 19 are symmetrical (FIG. 4, FIG. 6, FIG. 13 and FIG. 15) but also when the sets of cutouts 17, 19 are not symmetrical (FIG. 5, FIG. 14).

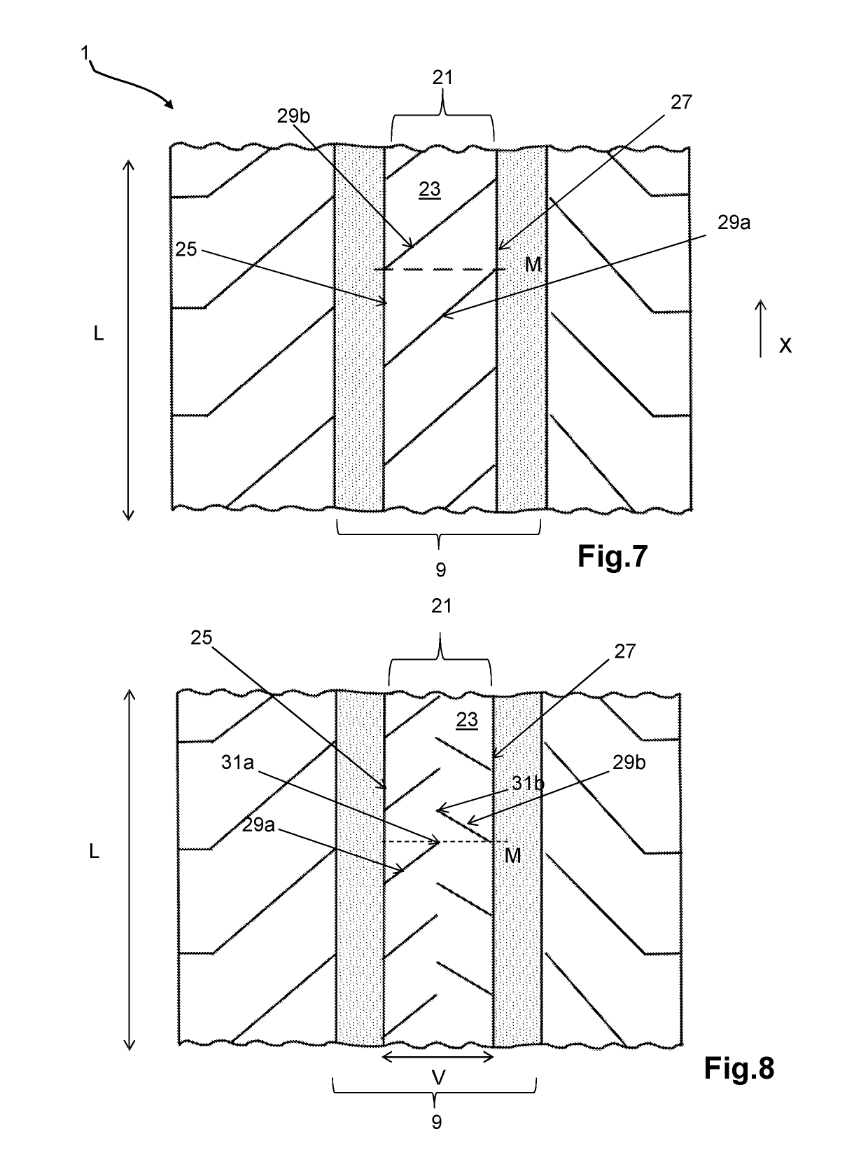

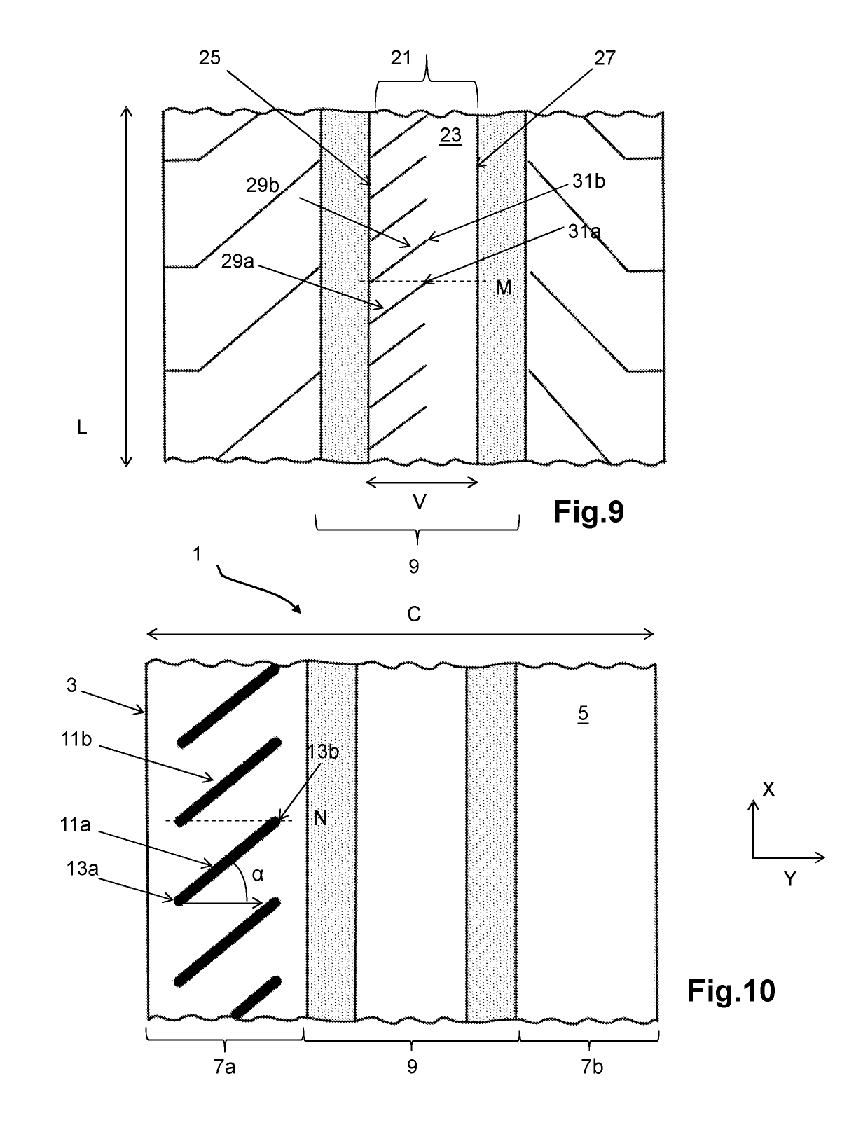

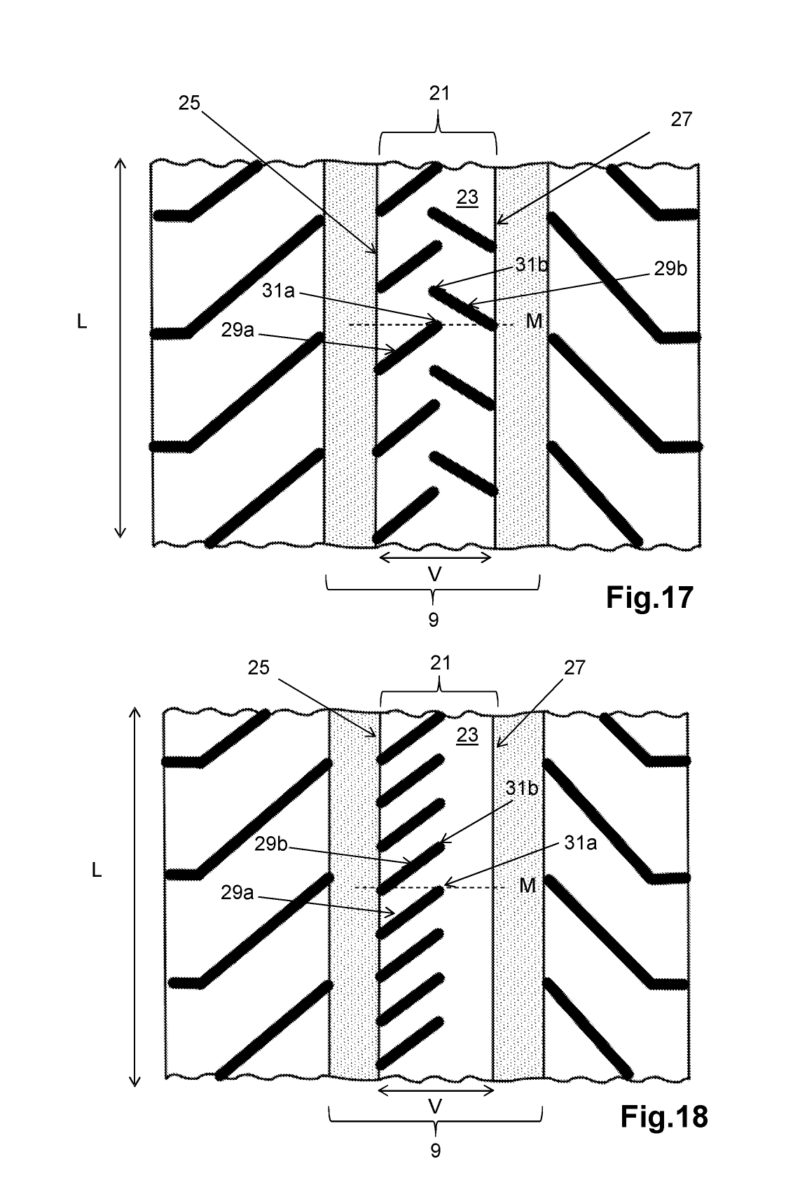

FIGS. 7 to 9 and FIGS. 16 to 18 describe embodiments in which the central region 9 of the tread comprises at least one elongate block 21. This elongate block is provided with a plurality of cutouts 29a, 29b. In FIG. 7 and in FIG. 16, the cutouts 29a, 29b are distributed over the contact surface of the elongate block such that when a cutout 29a reaches a second lateral wall 27 of the elongate block, another cutout 29b starts out from a first lateral wall 25 of this elongate block, at the same circumferential level M on the elongate block. In FIGS. 8 and 9 and in FIGS. 17 and 18, the cutouts 29a and 29b are interrupted and each extend as far as cutout ends. Each cutout end is aligned with the intersection between another cutout and a lateral wall of the elongate block. In FIG. 8 and in FIG. 17, the cutouts open either onto the first lateral wall 25 or onto the second lateral wall 27. In FIG. 9 and in FIG. 18, the cutouts open onto one and the same first lateral wall 25.

In a preferred embodiment, the sets of cutouts present in the shoulder regions are offset circumferentially with respect to the cutouts present in the elongate block.

The invention is not limited to the examples described and shown and various modifications can be made thereto without departing from its scope.

Thus, combinations of cutouts having different inclinations and/or different shapes and/or different lengths are possible. The noticeable features of the tread pattern noise spectrum are decreased, and the scrambling of the sound signal emitted by the tread pattern of the tire is thus improved.

In another embodiment, it is possible to provide for the cutouts to be chamfered at the contact surface of the elongate block.

1. A tire made of rubbery material comprising a tread, said tread having a width C measured between two edges of the tread, the tread comprising a tread surface adapted to come into contact with the ground, the tread surface comprising two shoulder regions surrounding a central region, at least one of the two shoulder regions comprising a plurality of successive cutouts in a circumferential direction, wherein all or some of the cutouts of the plurality of cutouts extend obliquely, each cutout having two ends, and wherein when a said cutout reaches one of its ends another said cutout starts out at the same circumferential level in the shoulder region, and wherein the cutouts are sipes.

2. A tire made of rubbery material comprising a tread, said tread having a width C measured between two edges of the tread, the tread comprising a tread surface adapted to come into contact with the ground, the tread surface comprising two shoulder regions surrounding a central region, at least one of the two shoulder regions comprising a plurality of successive cutouts in a circumferential direction, wherein all or some of the cutouts of the plurality of cutouts extend obliquely, each said cutout having two ends, and wherein when a said cutout reaches one of its ends, another said cutout starts out at the same circumferential level in the shoulder region, and wherein the cutouts are grooves.

3. The tire according to claim 1 or claim 2, wherein the oblique cutouts make an angle α with a transverse direction, said angle α being between 30 degrees and 60 degrees.

4. The tire according to claim 1 or claim 2, wherein the oblique cutouts are continued by generally transverse cutout extensions, said cutout extensions extending from ends of oblique cutouts that are proximal to an edge of the tread, and wherein the length of the cutout extensions is less than 10% of the width C of the tread.

5. The tire according to claim 1 or claim 2, wherein the oblique cutouts open into a circumferential groove belonging to the central region of the tread surface.

6. The tire according to claim 1 or claim 2, wherein each shoulder region comprises a set of oblique cutouts, and wherein the sets of cutouts of the two shoulder regions are symmetrical with respect to a median plane.

7. The tire according to claim 1 or claim 2, wherein each said shoulder region comprises a set of oblique cutouts, and wherein the sets of cutouts of the two shoulder regions are not symmetrical with respect to a median plane.

8. The tire according to claim 6, wherein the two sets of oblique cutouts are offset with respect to one another in the circumferential direction.

9. The tire according to claim 1 or claim 2, wherein the central region of the tread comprises at least one elongate block extending in the circumferential direction, the elongate block having a contact surface adapted to come into contact with the ground and a first lateral wall and a second lateral wall delimiting said contact surface, the elongate block comprising a plurality of cutouts that open onto the contact surface of the block, each one of said plurality of cutouts extending in an oblique direction and opening onto the first lateral wall and onto the second lateral wall, the cutouts in the block being oriented in the same direction, and wherein the plurality of cutouts are distributed over the contact surface of the elongate block such that when one of said plurality of cutouts reaches the second lateral wall, another of said plurality of cutouts starts out from the first lateral wall, at the same circumferential level on the elongate block.

10. The tire according to claim 1 or claim 2, wherein the central region comprises at least one elongate block extending in the circumferential direction of width W and length L, where L>>W, the elongate block comprising a contact surface adapted to come into contact with the ground and a first lateral wall and a second lateral wall delimiting this contact surface, the elongate block comprising a plurality of oblique cutouts that open either onto the first lateral wall or onto the second lateral wall and extend as far as cutout ends which do not open out onto said lateral walls, wherein the cutouts of the plurality of oblique cutouts follow one another longitudinally over the contact surface of the block such that when one of said plurality of oblique cutouts, opening onto the first lateral wall, reaches its cutout end, another of said plurality of oblique cutouts starts out from the second lateral wall, at the same circumferential level on the elongate block.

11. The tire according to claim 1 or 2, wherein the central region comprises at least one elongate block extending in the circumferential direction of width W and length L, where L>>W, the elongate block comprising a contact surface adapted to come into contact with the ground and a first lateral wall and a second lateral wall delimiting this contact surface, the elongate block comprising a plurality of cutouts that follow one another longitudinally and open onto the contact surface of the elongate block, the plurality of cutouts extending in an oblique direction from the first lateral wall in the direction of the second lateral wall as far as cutout ends, wherein, for at least one of said plurality of cutouts opening onto the first lateral wall, its end does not open onto the second lateral wall, and wherein when said at least one of said plurality of cutouts reaches its cutout end, another of said plurality of cutouts starts out from the first lateral wall, at the same circumferential level on the elongate block.

12. The tire according to claim 9, wherein the elongate block is a rib.

13. The tire according to claim 10, wherein the elongate block is a rib.

14. The tire according to claim 11, wherein the elongate block is a rib.

15. The tire according to claim 7, wherein the two sets of oblique cutouts are offset with respect to one another in the circumferential direction.
